(19) United States
(12) Patent Application Publication
(10) Pub. No.: US 2024/0077662 A1
(43) Pub. Date: Mar. 7, 2024

(54) STRUCTURAL COLOR MULTILAYER STRUCTURES HAVING BARRIER LAYERS

(71) Applicant: Toyota Motor Engineering & Manufacturing North America, Inc., Plano, TX (US)

(72) Inventors: Songtao Wu, Ann Arbor, MI (US); Debasish Banerjee, Ann Arbor, MI (US); Minjuan Zhang, Ann Arbor, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/116,600

(22) Filed: Mar. 2, 2023

Related U.S. Application Data
(60) Provisional application No. 63/404,413, filed on Sep. 7, 2022.

(51) Int. Cl. G02B 5/28

(52) U.S. Cl. CPC G02B 5/285

(57) ABSTRACT

A multilayer structure that reflects color having a core layer and a conformal dielectric layer encapsulating the core layer. A conformal barrier layer encapsulates the conformal dielectric layer, and a conformal absorber layer encapsulates the conformal barrier layer.

### CROSS-REFERENCE TO RELATED APPLICATION

This application claims the benefit of priority under 35 U.S.C. § 119 of U.S. Provisional Application Ser. No. 63/404,413 filed on Sep. 7, 2022, the content of which is relied upon and incorporated herein by reference in its entirety.

### FIELD

The present application is related to multilayer structures, and in particular to multilayer structures comprising multilayer structures containing metal and metal oxide over a substrate for optical applications. At least one of the metal and metal oxide are deposited by atomic layer deposition (ALD), and a barrier layer is positioned between each adjacent metal and/or metal oxide layer.

### BACKGROUND

Pigments made from multilayer structures are known. In addition, pigments that exhibit or provide a high-chroma structural color are also known. However, forming multilayer structures out of certain materials can be difficult because the deposition techniques for depositing various materials can have a negative impact on previously deposited materials. In addition, certain deposition techniques can be costly and time consuming making it very difficult to achieve commercially viable multilayer structures.

It is appreciated that the color produced by multilayer structure is dependent on the materials used as the various layers, the location of materials within the multilayer structure, and the properties of the individual layers (e.g., thickness). Accordingly, small variations in multilayer structure design can have a distinct impact on the color produced by the multilayer structure. However, conventional deposition techniques are not always effective for depositing the desired layers within a multilayer structure to achieve the best combinations for multilayer structures.

### SUMMARY

According to embodiments, a multilayer structure that reflects color comprises: a core layer; a conformal dielectric layer encapsulating the core layer; a conformal barrier layer encapsulating the conformal dielectric layer; and a conformal absorber layer encapsulating the conformal barrier layer.

According to embodiments, the multilayer structure further comprises: a second conformal barrier layer encapsulating the conformal absorber layer; and a second conformal dielectric layer encapsulating the second conformal barrier layer.

According to embodiments, a method for making the multilayer structure comprises: depositing the conformal dielectric layer onto the core layer by CVD or ALD; depositing the conformal barrier layer onto the conformal dielectric layer by ALD; and depositing the conformal absorber layer onto the conformal dielectric layer by ALD.

Additional features and advantages will be set forth in the detailed description that follows, and in part will be readily apparent to those skilled in the art from that description or recognized by practicing the embodiments described herein, including the detailed description that follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a multilayer structure according to embodiments disclosed and described herein;

FIG. 2A depicts a multilayer structure with a dielectric layer extending over a reflective core layer used in the design of a multilayer structure;

FIG. 2B depicts a multilayer structure with an absorber layer extending over a reflective core layer used in the design of a multilayer structure;

FIG. 2C depicts a multilayer structure with a dielectric layer extending over a reflective core layer used in the design of multilayer structures according to one or more embodiments shown and described herein;

FIG. 3 depicts reflectance properties of the multilayer structures illustrated in FIGS. 2A-2C on a Lab color space;

FIG. 4A graphically depicts chroma and hue values as a function of dielectric layer thickness for the multilayer structure illustrated in FIG. 2A;

FIG. 4B graphically depicts chroma and hue values as a function of semiconductor absorber layer thickness for the multilayer structure illustrated in FIG. 2B;

FIG. 4C graphically depicts chroma and hue values as a function of dielectric layer thickness for the multilayer structure illustrated in FIG. 2C;

FIG. 5 depicts a multilayer structure with a dielectric layer extending over a substrate layer and exposed to electromagnetic radiation at an angle θ relative to a normal direction to the outer surface of the dielectric layer;

FIG. 6A is a transmission electron microscope (TEM) image of a multilayer structure having protective and barrier layers according to embodiments disclosed and described herein;

FIG. 6B is a further-magnified TEM image of a multilayer structure having protective and barrier layers according to embodiments disclosed and described herein;

FIG. 6C is a TEM image of a multilayer structure having protective and barrier layers according to embodiments disclosed and described herein with elemental aluminum highlighted;

FIG. 6D is a TEM image of a multilayer structure having protective and barrier layers according to embodiments disclosed and described herein with elemental oxygen highlighted;

FIG. 6E is a TEM image of a multilayer structure having protective and barrier layers according to embodiments disclosed and described herein with elemental tungsten highlighted;

FIG. 6F is a TEM image of a multilayer structure having protective and barrier layers according to embodiments disclosed and described herein with elemental titanium highlighted;

FIG. 7A is a TEM image of a multilayer structure without a barrier layer;

FIG. 7B is a further-magnified TEM image of a multilayer structure without a barrier layer;

FIG. 7C is a TEM image of a multilayer structure without a barrier layer with elemental aluminum highlighted;

FIG. 7D is a TEM image of a multilayer structure without a barrier layer with elemental oxygen highlighted;

FIG. 7E is a TEM image of a multilayer structure without a barrier layer with elemental tungsten highlighted; and

FIG. 7F is a TEM image of a multilayer structure without a barrier layer with elemental titanium highlighted.

### DETAILED DESCRIPTION

Preparing multilayer structures can be a complex, expensive process because, in part, very tight control over layer thicknesses is required. The deposition methods used to deposit layers can vary in complexity and cost depending on the material that makes up a given layer and the desired thickness of the layer.

In addition, it can be challenging to deposit layers directly on a core layer, such as an aluminum (Al) reflective core layer, by less expensive wet chemical methods as these methods require highly acidic or basic conditions. In addition, there are challenges to depositing precisely-controlled ultrathin absorber layers other than by vacuum coating methods. For instance, ALD can precisely deposit thin layers, but ALD is costly and time-consuming. In particular, the ALD methods conventionally used are low-volume and are cost prohibitive to manufacture at a commercial scale. Moreover, when attempts were made to increase the production volume, it was noticed that various metal and/or metal oxide layers overlapped one another and formed a mixed layer that could have an effect on the optical properties of the multilayer structure.

Embodiments of the multilayer structure described herein may be used to omnidirectionally reflect wavelengths of visible light over a range of angles of incidence or viewing (such as hues between 0° and 120°). It will be understood that the terms “electromagnetic wave,” “electromagnetic radiation,” and “light,” as used herein, may interchangeably refer to various wavelengths of light incidence on a multilayer structure and that such light may have wavelengths in the ultraviolet (UV), infrared (IR), and visible portions of the electromagnetic spectrum.

As used herein, a “core layer” refers to a reflective core layer and a non-reflective core layer, and the “core layer” may have any shape including, but not limited to a flake, a sphere, an ovoid, and the like. As used herein, an “absorber layer” includes a metallic absorber layer and a non-metallic absorber layer.

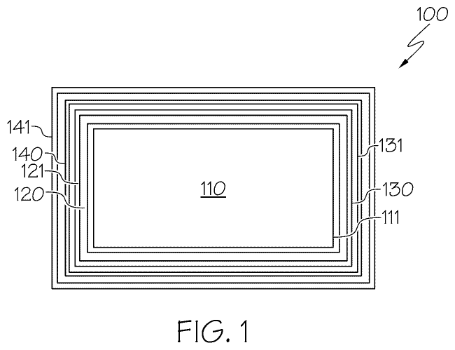

Referring now to FIG. 1, a multilayer structure 100 according to embodiments disclosed and described herein comprises a core layer 110, a first conformal protective layer 111 that encapsulates the core layer 110, a conformal dielectric layer 120 that encapsulates the first conformal protective layer 111, a conformal barrier layer 121 that encapsulates the conformal dielectric layer 120, a conformal absorber layer 130 that encapsulates the conformal barrier layer 121, a second conformal barrier layer 131 that encapsulates the conformal absorber layer 130, a second conformal dielectric layer 140 that encapsulates the second conformal barrier layer 131, and a conformal outer layer 141 that encapsulates the second conformal dielectric layer 140.

In one or more embodiments, the multilayer structure 100 may comprise less layers than those depicted in FIG. 1. For instance, in embodiments, a multilayer structure 100 comprises a core layer 110, a first conformal protective layer 111 that encapsulates the core layer 110, a conformal dielectric layer 120 that encapsulates the first conformal protective layer 111, a conformal barrier layer 121 that encapsulates the conformal dielectric layer 120, a conformal absorber layer 130 that encapsulates the conformal barrier layer 121, a second conformal barrier layer 131 that encapsulates the conformal absorber layer 130, and a second conformal dielectric layer 140 that encapsulates the second conformal barrier layer 131.

In one or more embodiments, a multilayer structure 100 comprises a core layer 110, a conformal dielectric layer 120 that encapsulates the core layer 110, a conformal barrier layer 121 that encapsulates the conformal dielectric layer 120, a conformal absorber layer 130 that encapsulates the conformal barrier layer 121, a second conformal barrier layer 131 that encapsulates the conformal absorber layer 130, and a second conformal dielectric layer 140 that encapsulates the second conformal barrier layer 131. An optional conformal outer layer 141 may encapsulate the second conformal dielectric layer 140.

In embodiments, a multilayer structure 100 comprises a core layer 110, a conformal dielectric layer 120 that encapsulates the core layer 110, a conformal barrier layer 121 that encapsulates the conformal dielectric layer 120, and a conformal absorber layer 130 that encapsulates the conformal barrier layer 121. A protective layer may optionally encapsulate the conformal absorber layer.

In one or more embodiments, a multilayer structure 100 comprises a core layer 110, a first conformal protective layer 111 that encapsulates the core layer 110, a conformal dielectric layer 120 that encapsulates the first conformal protective layer 111, a conformal barrier layer 121 that encapsulates the conformal dielectric layer 120, and a conformal absorber layer 130 that encapsulates the conformal barrier layer 121. A second conformal barrier layer 131 may optionally encapsulate the conformal absorber layer 130.

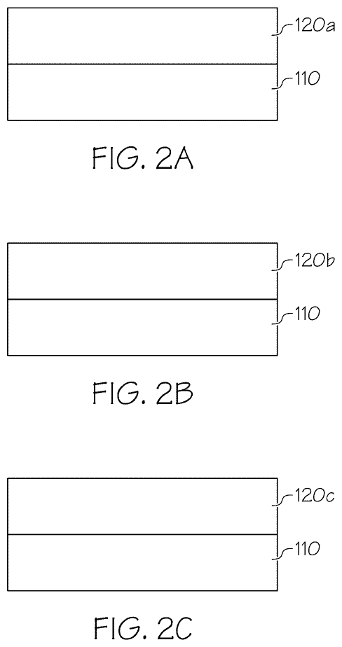

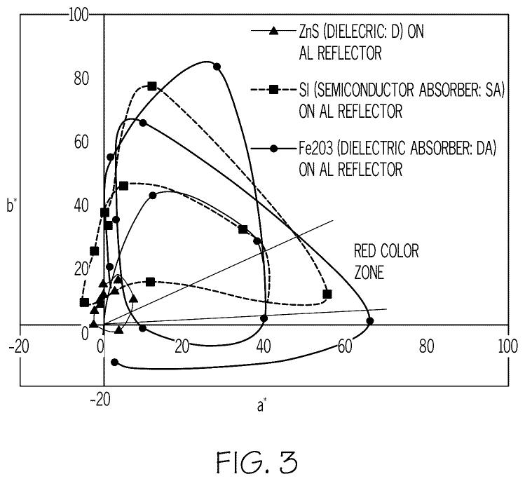

Referring to FIGS. 2A-2C and 3, the effectiveness of different types of layers extending across a reflective core layer 110 in attaining a desired hue level in a red region of the visible light spectrum as plotted or shown on a Lab color space is depicted. FIG. 2A depicts a ZnS dielectric layer 120a extending across a reflective core layer 110, FIG. 2B depicts a Si semiconductor absorber layer 120b extending across a reflective core layer 110, and FIG. 2C depicts an Fe₂O₃ absorber layer 120c extending across a reflective core layer 110. Simulations of the reflectance from each multilayer structure illustrated in FIGS. 2A-2C are performed as a function of different thicknesses for the dielectric layer 120a, the semiconductor absorber layer 120b, and absorber layer 120c. The results of the simulations are plotted on a Lab color space, also known as an a*b* color map, shown in FIG. 3. Each data point shown in FIG. 3 provides a chroma and a hue for particular thickness of the dielectric layer for the multilayer structure depicted in FIG. 2A, the semiconductor absorber layer for the multilayer structure depicted in FIG. 2B or the absorber layer for the multilayer structure depicted in FIG. 2C. Chroma can be defined as C=\sqrt{(a*²+b*²)} and hue can be defined as tan⁻¹(a*/b*). The hue can also be referred to as the angle relative to the positive a*-axis of a given data point. A hue value provides a measure of the color displayed by an object (e.g., red, green, blue, yellow etc.), and a chroma value provides a measure of the color's “brightness.” As shown in FIG. 3, the multilayer structure illustrated in FIG. 2A provides low chroma compared to the multilayer structures illustrated in FIGS. 2B and 2C. Accordingly, FIGS. 2A-2C and FIG. 3 demonstrate that an absorber layer, (e.g., an absorber layer) is preferred over a dielectric layer as a first layer extending over a reflective core layer when colors with high chroma are desired. It should be understood that the Lab color space analysis shown in FIG. 3 is for illustrative purposes and that multilayer structures according to embodiments disclosed and described herein may have different Lab color space values. For instance, in embodiments, the multilayer structures could exhibit a blue, green, yellow, or other colors in the Lab color space.

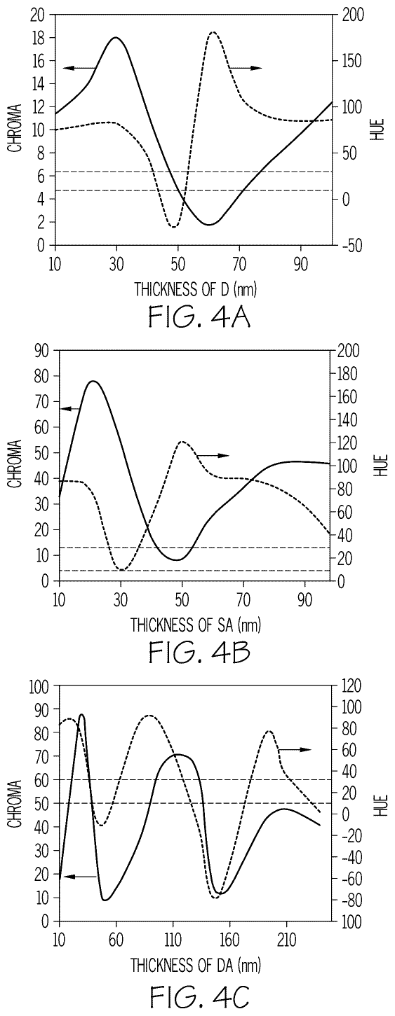

Referring to FIGS. 4A-4C, chroma and hue as a function of layer thickness is depicted. Specifically, FIG. 4A graphically depicts the chroma and hue as a function of the thickness of the ZnS dielectric layer extending over the Al reflective core layer illustrated in FIG. 2A. FIG. 4B depicts the chroma and hue as a function of the thickness of the Si semiconductor absorber layer extending over the Al reflective core layer illustrated in FIG. 2B. FIG. 4C depicts the chroma and hue as a function of the thickness of the Fe₂O₃ absorber layer extending over the Al reflective core layer illustrated in FIG. 2C. The dotted lines in FIGS. 4A-4C correspond to desired hue values between 10° and 30° on the Lab color space. FIGS. 4A-4C illustrate that higher chroma values within the hue range between 10° and 30° are achieved for multilayer structures having a absorber layer extending across the reflective core layer. Again, it should be understood that the hue and chroma shown in FIG. 4A-4C is for illustrative purposes and that multilayer structures according to embodiments disclosed and described herein may have different hue and chroma values.

Referring again to FIG. 1, a multilayer structure 100 includes a core layer 110, a first conformal protective layer 111 encapsulating the core layer 110, a conformal dielectric layer 120 encapsulating the first conformal protective layer 111, a first conformal barrier layer 121 encapsulating the conformal dielectric layer 120, a conformal absorber layer 130 encapsulating the first conformal barrier layer 121, a second conformal barrier layer 131 encapsulating the conformal absorber layer 130, a second conformal dielectric layer 140 encapsulating the second conformal barrier layer 131, and an optional conformal outer layer 141 encapsulating the second conformal dielectric layer 140. In embodiments, the “outer layer” has an outer free surface (i.e., an outer surface not in contact with an absorber layer or another dielectric layer that is not part of a protective coating). As shown in FIG. 1, embodiments of multilayer structures disclosed and described herein comprise a conformal dielectric layer 120 and a conformal absorber layer 130. As used herein, “conformal” is used to indicate that the layer conforms to the size and shape of the layer to which it is deposited and encapsulates (i.e., is present on all sides) of the layer to which it is deposited and conforms to the contours of the layer which it is deposited. Although FIG. 1 shows a rectangular structure, this is for illustrative purposes only, and often the multilayer structure will have an asymmetric and non-uniform shape. In embodiments, the multilayer structure may be spherical or ovoid. It should be understood that embodiments may also include a multilayer structure with a conformal absorber encapsulating the core layer, and a conformal dielectric layer encapsulating the conformal absorber layer.

In embodiments, the core layer 110 can have a thickness that is greater than or equal to 20 nm and less than or equal to 100 μm, such as greater than or equal to 50 nm and less than or equal to 80 μm, greater than or equal to 75 nm and less than or equal to 60 μm, greater than or equal to 100 nm and less than or equal to 40 μm, greater than or equal to 125 nm and less than or equal to 20 μm, or greater than or equal to 150 nm and less than or equal to 1 μm. The core layer 110 can, in one or more embodiments, have a thickness between 50 nm and 10 μm, such as between 100 nm and 10 μm, between 250 nm and 10 μm, between 500 nm and 10 μm, between 750 nm and 10 μm, between 1 μm and 10 μm, between 2 μm and 10 μm, between 5 μm and 10 μm, between 8 μm and 10 μm, between 50 nm and 8 μm, between 100 nm and 8 μm, between 250 nm and 8 μm, between 500 nm and 8 μm, between 750 nm and 8 μm, between 1 μm and 8 μm, between 2 μm and 8 μm, between 5 μm and 8 μm, between 50 nm and 5 μm, between 100 nm and 5 μm, between 250 nm and 5 μm, between 500 nm and 5 μm, between 750 nm and 5 μm, between 1 μm and 5 μm, between 2 μm and 5 μm, between 50 nm and 2 μm, between 100 nm and 2 μm, between 250 nm and 2 μm, between 500 nm and 2 μm, between 750 nm and 2 μm, between 1 μm and 2 μm, between 50 nm and 1 μm, between 100 nm and 1 μm, between 250 nm and 1 μm, between 500 nm and 1 μm, between 750 nm and 1 μm, between 50 nm and 750 nm, between 100 nm and 750 nm, between 250 nm and 750 nm, between 500 nm and 750 nm, between 50 nm and 500 nm, between 100 nm and 500 nm, between 250 nm and 500 nm, between 50 nm and 250 nm, between 100 nm and 250 nm, or between 50 nm and 100 nm.

In embodiments, the core layer 110 can be made from at least one of a “gray metallic” material, such as Al, Ag, Pt, Sn; at least one of a “colorful metallic” material, such as Au, Cu, brass, bronze, TiN, Cr, stainless steel, or a combination thereof. In one or more embodiments, the core layer 110 can be made from an oxide, such as alumina (Al₂O₃), silica (SiO₂), bismuth oxychloride, or glass materials. The core layer 110 can have plate-like shape or can be spherical or ovoid, as mentioned above.

In one or more embodiments, the first conformal protective layer 111 has a thickness that is less than or equal to 50 nm and greater than or equal to 5 nm, such as less than or equal to 40 nm and greater than or equal to 5 nm, less than or equal to 30 nm and greater than or equal to 5 nm, less than or equal to 20 nm and greater than or equal to 5 nm, less than or equal to 10 nm and greater than or equal to 5 nm, less than or equal to 50 nm and greater than or equal to 10 nm, less than or equal to 40 nm and greater than or equal to 10 nm, less than or equal to 30 nm and greater than or equal to 10 nm, less than or equal to 20 nm and greater than or equal to 10 nm, less than or equal to 50 nm and greater than or equal to 20 nm, less than or equal to 40 nm and greater than or equal to 20 nm, less than or equal to 30 nm and greater than or equal to 20 nm, less than or equal to 50 nm and greater than or equal to 30 nm, less than or equal to 40 nm and greater than or equal to 30 nm, or less than or equal to 50 nm and greater than or equal to 40 nm.

The first conformal protective layer 111 may, in embodiments, be formed from a chromate coating, a phosphate coating, an oxide coating (such as SiO₂), and may be applied to the core layer 110 by chemical vapor deposition (CVD), physical vapor deposition (PVD), wet chemical methods, or ALD.

According to one or more embodiments, the conformal dielectric layer 120 has a thickness that is greater than or equal to 5 nm and less than or equal to 500 nm, such as greater than or equal to 10 nm and less than or equal to 475 nm, greater than or equal to 10 nm and less than or equal to 450 nm, greater than or equal to 10 nm and less than or equal to 425 nm, greater than or equal to 10 nm and less than or equal to 400 nm, greater than or equal to 10 nm and less than or equal to 375 nm, greater than or equal to 10 nm and less than or equal to 350 nm, greater than or equal to 10 nm and less than or equal to 325 nm, or greater than or equal to 10 nm and less than or equal to 300 nm. The conformal dielectric layer 120 can, according to embodiments, have a thickness between 5 nm and 300 nm, such as between 10 nm and 300 nm, between 15 nm and 300 nm, between 25 nm and 300 nm, between 50 nm and 300 nm, between 75 nm and 300 nm, between 100 nm and 300 nm, between 125 nm and 300 nm, between 150 nm and 300 nm, between 175 nm and 300 nm, between 200 nm and 300 nm, between 225 nm and 300 nm, between 250 nm and 300 nm, between 275 nm and 300 nm, between 5 nm and 275 nm, between 10 nm and 275 nm, between 15 nm and 275 nm, between 25 nm and 275 nm, between 50 nm and 275 nm, between 75 nm and 275 nm, between 100 nm and 275 nm, between 125 nm and 275 nm, between 150 nm and 275 nm, between 175 nm and 275 nm, between 200 nm and 275 nm, between 225 nm and 275 nm, between 250 nm and 275 nm, between 5 nm and 250 nm, between 10 nm and 250 nm, between 15 nm and 250 nm, between 25 nm and 250 nm, between 50 nm and 250 nm, between 75 nm and 250 nm, between 100 nm and 250 nm, between 125 nm and 250 nm, between 150 nm and 250 nm, between 175 nm and 250 nm, between 200 nm and 250 nm, between 225 nm and 250 nm, between 5 nm and 225 nm, between 10 nm and 225 nm, between 15 nm and 225 nm, between 25 nm and 225 nm, between 50 nm and 225 nm, between 75 nm and 225 nm, between 100 nm and 225 nm, between 125 nm and 225 nm, between 150 nm and 225 nm, between 175 nm and 225 nm, between 200 nm and 225 nm, between 5 nm and 200 nm, between 10 nm and 200 nm, between 15 nm and 200 nm, between 25 nm and 200 nm, between 50 nm and 200 nm, between 75 nm and 200 nm, between 100 nm and 200 nm, between 125 nm and 200 nm, between 150 nm and 200 nm, between 175 nm and 200 nm, between 5 nm and 175 nm, between 10 nm and 175 nm, between 15 nm and 175 nm, between 25 nm and 175 nm, between 50 nm and 175 nm, between 75 nm and 175 nm, between 100 nm and 175 nm, between 125 nm and 175 nm, between 150 nm and 175 nm, between 5 nm and 150 nm, between 10 nm and 150 nm, between 15 nm and 150 nm, between 25 nm and 150 nm, between 50 nm and 150 nm, between 75 nm and 150 nm, between 100 nm and 150 nm, between 125 nm and 150 nm, between 5 nm and 100 nm, between 10 nm and 100 nm, between 15 nm and 100 nm, between 25 nm and 100 nm, between 50 nm and 100 nm, between 75 nm and 100 nm, between 5 nm and 75 nm, between 10 nm and 75 nm, between 15 nm and 75 nm, between 25 nm and 75 nm, between 50 nm and 75 nm, between 5 nm and 50 nm, between 10 nm and 50 nm, between 15 nm and 50 nm, between 25 nm and 50 nm, between 5 nm and 25 nm, between 10 nm and 25 nm, between 15 nm and 25 nm, between 5 nm and 15 nm, between 10 nm and 15 nm, or between 5 nm and 10 nm.

The first conformal dielectric layer 120 is, in embodiments, a high refractive index material, such as TiO₂ (including anatase, rutile, or amorphous TiO₂ and mixtures thereof), ZnS, ZrO₂, HfO₂, Fe₃O₄, or AlAs. In one or more embodiments, the conformal dielectric layer 120 may be made from high refractive index absorptive dielectric materials such as Fe₂O₃, PbS, GaAs, or InAs. In embodiments, the conformal dielectric layer may be made from a low refractive index material, such as SiO₂, MgF₂, KBr, ZnO, or Al₂O₃. The conformal dielectric layer 120 can, in embodiments, be deposited to encapsulate the core layer 110 by CVD, PVD, wet chemical methods, or ALD.

In embodiments, the first conformal barrier layer 121 has a thickness that is less than or equal to 50 nm, such as less than or equal to 45 nm, less than or equal to 40 nm, less than or equal to 35 nm, less than or equal to 30 nm, less than or equal to 25 nm, less than or equal to 20 nm, as less than or equal to 15 nm, less than or equal to 10 nm, less than or equal to 5 nm, or less than or equal to 2 nm. The barrier layer, according to embodiments, has a thickness that is greater than or equal to 1 nm and less than or equal to 50 nm, such as greater than or equal to 1 nm and less than or equal to 45 nm, greater than or equal to 1 nm and less than or equal to 40 nm, greater than or equal to 1 nm and less than or equal to 35 nm, greater than or equal to 1 nm and less than or equal to 30 nm, or greater than or equal to 1 nm and less than or equal to 25 nm. In one or more embodiments, the barrier layer has a thickness that is greater than or equal to 1 nm and less than or equal to 20 nm, such as greater than or equal to 1 nm and less than or equal to 15 nm, greater than or equal to 1 nm and less than or equal to 10 nm, greater than or equal to 1 nm and less than or equal to 5 nm, greater than or equal to 1 nm and less than or equal to 2 nm, greater than or equal to 2 nm and less than or equal to 20 nm, greater than or equal to 2 nm and less than or equal to 15 nm, greater than or equal to 2 nm and less than or equal to 10 nm, greater than or equal to 2 nm and less than or equal to 5 nm, greater than or equal to 5 nm and less than or equal to 20 nm, greater than or equal to 5 nm and less than or equal to 15 nm, greater than or equal to 5 nm and less than or equal to 10 nm, greater than or equal to 10 nm and less than or equal to 20 nm, greater than or equal to 10 nm and less than or equal to 20 nm, greater than or equal to 15 nm and less than or equal to 20 nm, or greater than or equal to 15 nm and less than or equal to 20 nm.

The first conformal barrier layer 121 may, in embodiments, be formed from Al₂O₃, SiO₂, MgF₂, KBr, or ZnO, and may be applied to the first conformal dielectric layer 120 by ALD.

A conformal absorber layer 130 encapsulates the first conformal barrier layer 121. The location of the conformal absorber layer 130 is chosen to increase the absorption of target light wavelengths. For instance, if the multilayer structure is to be configured to absorb electromagnetic radiation having wavelengths that are less than or equal to 550 nm but reflect electromagnetic radiation with wavelengths of approximately 650 nm, such as visible light outside of the hue between 10° and 30°, the absorber layer is placed at a thickness where the electric field (|E|²) is less at the 550 nm wavelength than at the 650 nm wavelength. Mathematically, this can be expressed as:

E₅₅₀|²<<|E₆₅₀|² (1)

and preferably:

|E₆₅₀|²≈0 (2)

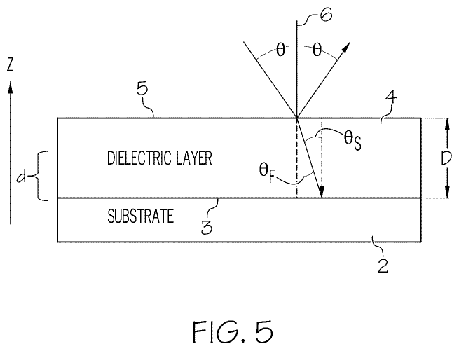

FIG. 5 and the following discussion provide a method for calculating the thickness of a zero or near-zero electric field point at a given wavelength of light, according to embodiments. For the purposes of the present specification, the term “near-zero” is defined |E|²≤10. FIG. 5 illustrates a multilayer structure with a dielectric layer 4 having a total thickness “D”, an incremental thickness “d” and an index of refraction “n” on a substrate layer 2 having an index of refraction “nₛ”. The substrate layer 2 can be a core layer or a reflective core layer of a multilayer structure. Incident light strikes the outer surface 5 of the dielectric layer 4 at angle θ relative to line 6, which is perpendicular to the outer surface 5, and reflects from the outer surface 5 at the same angle θ. Incident light is transmitted through the outer surface 5 and into the dielectric layer 4 at an angle θ_{F} relative to the line 6 and strikes the surface 3 of substrate layer 2 at an angle θₛ. For a single dielectric layer, θₛ=θ_{F} and the energy/electric field (E) can be expressed as E(z) when z=d. From Maxwell's equations, the electric field can be expressed for s polarization as:

\vec{E}(d)={u(z),0,0}exp(ikαy)|_{z=d} (3)

and for p polarization as:

$$\vec{E} ( d ) = \{ 0 , u ( z ) , - \frac{α}{\tilde{ε} ( z )} v ( z ) \} exp ( ik α y ) {\vert}_{z = d} \qquad ( 4 )$$

where

$$k = \frac{2 π}{λ} , λ$$

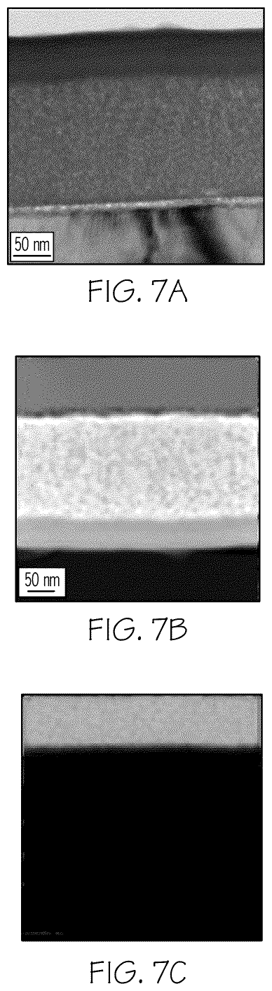

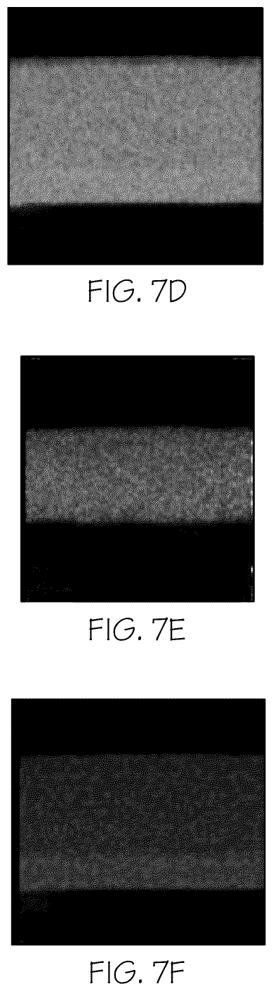

is a desired wavelength to be reflected, α=nₛ sin θₛ, where “s” corresponds to the substrate in FIG. 7, and \tilde{ε}(z) is the permittivity of the layer as a function of z. As such:

|E(d)|²=|u(z)|²exp(2ikαy)|_{z=d} (5)

for s polarization, and

$$\vert {E ( d )}^{2} \vert = [ {\vert u ( z ) \vert}^{2} + \vert \frac{α}{\sqrt{n}} v ( z ) {\vert}^{2} ] exp ( 2 ik α y ) {\vert}_{z = d} \qquad ( 6 )$$

for p polarization.

It should be appreciated that variation of the electric field along the Z direction of the dielectric layer 4 can be estimated by calculation of the unknown parameters u(z) and v(z), where it can be shown that:

$${( \begin{matrix}u \\ v\end{matrix} )}_{z = d} = ( \begin{matrix}cos φ & ( i / q ) sin φ \\ iq sin φ & cos φ\end{matrix} ) {( \begin{matrix}u \\ v\end{matrix} )}_{z = 0 , substrate} \qquad ( 7 )$$

where ‘i’ is the square root of −1. Using the boundary conditions u|_{z=0}=1, v|_{z=0}=qₛ, and the following relations:

qₛ=nₛ cos θₛ for s-polarization (8)

qₛ=nₛ/cos θₛ for p-polarization (9)

q=n cos θ_{F} for s-polarization (10)

q=n/cos θ_{F} for p-polarization (11)

φ=k·n·d cos(θ_{F}) (12)

u(z) and v(z) can be expressed as:

$$\begin{matrix}u ( z ) {\vert}_{z = d} = u {\vert}_{z = 0} cos φ + v {\vert}_{z = o} ( \frac{1}{q} sin φ ) \\ = cos φ + \frac{i . {q}_{s}}{q} sin φ\end{matrix} \qquad ( 13 )$$

$$and$$

$$\begin{matrix}v ( z ) {\vert}_{z = d} = iqu {\vert}_{z = 0} sin φ + v {\vert}_{z = 0} cos φ \\ = iq sin φ + {q}_{s} cos φ\end{matrix} \qquad ( 14 )$$

Therefore:

$$\begin{matrix}\vert {E ( d )}^{2} \vert = [ {cos}^{2} φ + \frac{{q}_{s}^{2}}{{q}^{2}} {sin}^{2} φ ] {e}^{2 ik αγ} \\ = [ {cos}^{2} φ + \frac{{n}_{s}^{2}}{{n}^{2}} {sin}^{2} φ ] {e}^{2 ik a γ}\end{matrix} \qquad ( 15 )$$

for s polarization with φ=k·n·d cos(θ_{F}), and:

$$\begin{matrix}\vert {E ( d )}^{2} \vert = [ {cos}^{2} φ + \frac{{n}_{s}^{2}}{{n}^{2}} {sin}^{2} φ + \frac{{α}^{2}}{n} ( {q}_{s}^{2} {cos}^{2} φ + {q}^{2} {sin}^{2} φ ) ] \\ = [ ( 1 + \frac{{α}^{2} {q}_{s}^{2}}{n} ) {cos}^{2} φ + ( \frac{{n}_{s}^{2}}{{n}^{2}} + \frac{{α}^{2} {q}^{2}}{n} ) {sin}^{2} φ ]\end{matrix} \qquad ( 16 )$$

for p polarization where:

$$α = {n}_{s} sin {θ}_{s} = n sin {θ}_{F} \qquad ( 17 )$$

$${q}_{s} = \frac{{n}_{s}}{cos {θ}_{s}} \qquad ( 18 )$$

$$and$$

$${q}_{s} = \frac{n}{cos {θ}_{F}} \qquad ( 19 )$$

Thus for a simple situation where θ_{F}=0 or normal incidence, φ=k·n·d, and α=0:

$$\vert {E ( d )}^{2} \vert for s - polarization = \vert {E ( d )}^{2} \vert for p - polarization = [ {cos}^{2} φ + \frac{{n}_{s}^{2}}{{n}^{2}} {sin}^{2} φ ] \qquad ( 20 )$$

$$= [ {cos}^{2} ( k \cdot n \cdot d ) + \frac{{n}_{s}^{2}}{{n}^{2}} {sin}^{2} ( k \cdot n \cdot d ) ] \qquad ( 21 )$$

which allows for the thickness “d” to be solved for (i.e., the position or location within the dielectric layer where the electric field is zero). It should be appreciated that the thickness “d” can be the thickness of the first conformal dielectric layer 120, the first conformal barrier layer 121, and the first conformal protective layer 111 that encapsulate the core layer 110 and that provides a zero or near zero electric field at the interface between the first conformal dielectric layer 120 and the conformal absorber layer 130. It should also be appreciated that the thickness “d” can also be the thickness of the second conformal dielectric layer 140 encapsulating the second conformal barrier layer 131 that provides a zero or near zero electric field at the interface between the dielectric outer layer and the conformal absorber layer 130, depending on the thickness “d” where the electric field is zero or near-zero.

In embodiments, the conformal absorber layer has a thickness that is from greater than or equal to 2 nm and less than or equal to 50 nm, such as greater than or equal to 2 nm and less than or equal to 45 nm, greater than or equal to 2 nm and less than or equal to 40 nm, greater than or equal to 2 nm and less than or equal to 35 nm, greater than or equal to 2 nm and less than or equal to 30 nm, or greater than or equal to 2 nm and less than or equal to 25 nm. The conformal absorber layer 130 can, in embodiments, have a thickness between 2 nm and 20 nm, such as between 5 nm and 20 nm, between 8 nm and 20 nm, between 10 nm and 20 nm, between 12 nm and 20 nm, between 15 nm and 20 nm, between 18 nm and 20 nm, between 2 nm and 18 nm, between 5 nm and 18 nm, between 8 nm and 18 nm, between 10 nm and 18 nm, between 12 nm and 18 nm, between 15 nm and 18 nm, between 2 nm and 15 nm, between 5 nm and 15 nm, between 8 nm and 15 nm, between 10 nm and 15 nm, between 12 nm and 15 nm, between 2 nm and 12 nm, between 5 nm and 12 nm, between 8 nm and 12 nm, between 10 nm and 12 nm, between 2 nm and 10 nm, between 5 nm and 10 nm, between 8 nm and 10 nm, between 2 nm and 8 nm, between 5 nm and 8 nm, or between 2 nm and 5 nm.

In embodiments, the conformal absorber layer 130 can be made from at least a material selected from W, Cr, Ge, Ni, stainless steel, Pd, Ti, Si, V, TiN, Co, Mo, Nb, ferric oxide, or combinations thereof. In one or more embodiments, the conformal absorber layer 130 is comprised of W. In embodiments, ALD is used to deposit the conformal absorber layer 130 because ALD allows uniform deposition of materials at the thicknesses desired. Other deposition methods have difficulty depositing uniform layers at thicknesses of 20 nm and below.

In embodiments, the second conformal barrier layer 121 has a thickness that is less than or equal to 50 nm, such as less than or equal to 45 nm, less than or equal to 40 nm, less than or equal to 35 nm, less than or equal to 30 nm, less than or equal to 25 nm, less than or equal to 20 nm, as less than or equal to 15 nm, less than or equal to 10 nm, less than or equal to 5 nm, or less than or equal to 2 nm. The second conformal barrier layer, according to embodiments, has a thickness that is greater than or equal to 1 nm and less than or equal to 50 nm, such as greater than or equal to 1 nm and less than or equal to 45 nm, greater than or equal to 1 nm and less than or equal to 40 nm, greater than or equal to 1 nm and less than or equal to 35 nm, greater than or equal to 1 nm and less than or equal to 30 nm, or greater than or equal to 1 nm and less than or equal to 25 nm. In one or more embodiments, the second conformal barrier layer has a thickness that is greater than or equal to 1 nm and less than or equal to 20 nm, such as greater than or equal to 1 nm and less than or equal to 15 nm, greater than or equal to 1 nm and less than or equal to 10 nm, greater than or equal to 1 nm and less than or equal to 5 nm, greater than or equal to 1 nm and less than or equal to 2 nm, greater than or equal to 2 nm and less than or equal to 20 nm, greater than or equal to 2 nm and less than or equal to 15 nm, greater than or equal to 2 nm and less than or equal to 10 nm, greater than or equal to 2 nm and less than or equal to 5 nm, greater than or equal to 5 nm and less than or equal to 20 nm, greater than or equal to 5 nm and less than or equal to 15 nm, greater than or equal to 5 nm and less than or equal to 10 nm, greater than or equal to 10 nm and less than or equal to 20 nm, greater than or equal to 10 nm and less than or equal to 20 nm, greater than or equal to 15 nm and less than or equal to 20 nm, or greater than or equal to 15 nm and less than or equal to 20 nm.

The second conformal barrier layer 131 may, in embodiments, be formed from SiO₂, MgF₂, KBr, ZnO, or Al₂O₃, and may be applied to the conformal absorber layer 130 by chemical vapor deposition (CVD), physical vapor deposition (PVD), wet chemical methods, or ALD.

The second conformal dielectric layer 140 can, in embodiments, have a thickness greater than 0.1 quarter wave (QW) to less than or equal to 4.0 QW where the control wavelength is determined by the target wavelength at the peak reflectance in the visible wavelength, such as between 0.5 QW and 4.0 QW, between 1.0 QW and 4.0 QW, between 1.5 QW and 4.0 QW, between 2.0 QW and 4.0 QW, between 2.5 QW and 4.0 QW, between 3.0 QW and 4.0 QW, or between 3.5 QW and 4.0 QW. In embodiments, the second conformal dielectric layer 140 can have a thickness from greater than 0.1 QW to less than 3.5 QW, such as from greater than 0.1 QW to less than 3.0 QW, from greater than 0.1 QW to less than 2.5 QW, from greater than 0.1 QW to less than 2.0 QW, from greater than 0.1 QW to less than 1.5 QW, from greater than 0.1 QW to less than 1.0 QW, or from greater than 0.1 QW to less than 0.5 QW. In some embodiments, the second conformal dielectric layer 140 can have a thickness from 0.5 QW to 3.5 QW, such as from 1.0 QW to 3.0 QW, or from 1.5 QW to 2.5 QW. In embodiments, the target wavelength may be about 1050 nm.

In embodiments, the second conformal dielectric layer 140 may be formed from TiO₂ (including anatase, rutile, or amorphous TiO₂ and mixtures thereof), ZnS, ZrO₂, HfO₂, Fe₃O₄, or AlAs. In one or more embodiments, the second conformal dielectric layer 140 may be made from high refractive index absorptive dielectric materials such as Fe₂O₃, PbS, GaAs, InAs. In embodiments, the second conformal dielectric layer 140 may be made from a low refractive index material, such as SiO₂, MgF₂, KBr, ZnO, or Al₂O₃. In embodiments, the second conformal dielectric layer 140 may be deposited by CVD or ALD.

In embodiments, the second conformal dielectric layer 140 can have a thickness between 5 and 500 nm, such as between 50 nm and 500 nm, between 100 nm and 500 nm, between 150 nm and 500 nm, between 200 nm and 500 nm, between 250 nm and 500 nm, between 300 nm and 500 nm, between 350 nm and 500 nm, between 400 nm and 500 nm, or between 450 nm and 500 nm. In some embodiments, the second conformal dielectric layer 140 can have a thickness between 5 nm and 450 nm, such as between 5 nm and 400 nm, between 5 nm and 350 nm, between 5 nm and 300 nm, between 5 nm and 250 nm, between 5 nm and 200 nm, between 5 nm and 150 nm, between 5 nm and 100 nm, or between 5 nm and 50 nm. In embodiments, the second conformal dielectric layer 140 can have a thickness between 50 nm to 450 nm, such as between 100 nm to 400 nm, between 150 nm to 350 nm, or between 200 nm to 300 nm.

The conformal outer layer 141 has, according to embodiments, a thickness that is less than or equal to 50 nm and greater than or equal to 5 nm, such as less than or equal to 40 nm and greater than or equal to 5 nm, less than or equal to 30 nm and greater than or equal to 5 nm, less than or equal to 20 nm and greater than or equal to 5 nm, less than or equal to 10 nm and greater than or equal to 5 nm, less than or equal to 50 nm and greater than or equal to 10 nm, less than or equal to 40 nm and greater than or equal to 10 nm, less than or equal to 30 nm and greater than or equal to 10 nm, less than or equal to 20 nm and greater than or equal to 10 nm, less than or equal to 50 nm and greater than or equal to 20 nm, less than or equal to 40 nm and greater than or equal to 20 nm, less than or equal to 30 nm and greater than or equal to 20 nm, less than or equal to 50 nm and greater than or equal to 30 nm, less than or equal to 40 nm and greater than or equal to 30 nm, or less than or equal to 50 nm and greater than or equal to 40 nm.

The conformal outer layer 141 may, in embodiments, be formed from silicon dioxide (SiO₂) MgF₂, KBr, ZnO, Al₂O₃, and may be applied to the conformal absorber layer 130 by CVD, PVD, wet chemical methods, or ALD.

In one or more embodiments, each of the core layer 110, the first conformal dielectric layer 120, the conformal absorber layer 130, and the second conformal dielectric layer 140 individually has a pore volume that is less than or equal to 0.030 cm³/g, such as less than or equal to 0.025 cm³/g, less than or equal to 0.020 cm³/g, or less than or equal to 0.015 cm³/g. In embodiments, each of the core layer 110, the first conformal dielectric layer 120, the conformal absorber layer 130, and the second conformal dielectric layer 140 individually has a pore volume that is less than or equal to 0.010 cm³/g, such as less than or equal to 0.009 cm³/g, less than or equal to 0.008 cm³/g, less than or equal to 0.007 cm³/g, less than or equal to 0.006 cm³/g, less than or equal to 0.005 cm³/g pore volume, less than or equal to 0.004 cm³/g, less than or equal to 0.003 cm³/g, less than or equal to 0.002 cm³/g, less than or equal to 0.001 cm³/g. It should be understood that in embodiments one or more of the core layer 110, the first conformal dielectric layer 120, the conformal absorber layer 130, and the second conformal dielectric layer 140 may have the same pore volume and in other embodiments one or more of the core layer 110, the first conformal dielectric layer 120, the conformal absorber layer 130, and the second conformal dielectric layer 140 may have different pore volume.

In one or more embodiments the surface area of the each of the core layer 110, the first conformal dielectric layer 120, the conformal absorber layer 130, and the second conformal dielectric layer 140 individually is less than or equal to 100 square meters per gram (m²/g), such as less than or equal to 90 m²/g, less than or equal to 85 m²/g, less than or equal to 80 m²/g, less than or equal to 75 m²/g, less than or equal to 70 m²/g, less than or equal to 65 m²/g, less than or equal to 60 m²/g, less than or equal to 55 m²/g, less than or equal to 50 m²/g, less than or equal to 45 m²/g, less than or equal to 40 m²/g, less than or equal to 35 m²/g, less than or equal to 30 m²/g, less than or equal to 25 m²/g, less than or equal to 20 m²/g, or less than or equal to 15 m²/g. The surface area, in embodiments, of the each of the core layer 110, the first conformal dielectric layer 120, the conformal absorber layer 130, and the second conformal dielectric layer 140 individually is less than or equal to 10 m²/g, such as less than or equal to 9 m²/g, less than or equal to 8 m²/g, less than or equal to 7 m²/g, less than or equal to 6 m²/g, less than or equal to 5 m²/g, less than or equal to 4 m²/g, less than or equal to 3 m²/g, less than or equal to 2 m²/g, or less than or equal to 1 m²/g. Accordingly, in embodiments, each of the layers may individually have a surface area from 2 m²/g to 10 m²/g, from 3 m²/g to 10 m²/g, from 3 m²/g to 8 m²/g, from 5 m²/g to 8 m²/g, from 1 m²/g to 3 m²/g, from 3 m²/g to 5 m²/g, from 2 m²/g to 3 m²/g, from 1 m²/g to 2 m²/g, or from 0.5 m²/g to 1 m²/g. It should be understood that in embodiments one or more of the core layer 110, the first conformal dielectric layer 120, the conformal absorber layer 130, and the second conformal dielectric layer 140 may have the same surface area and in other embodiments one or more of the core layer 110, the first conformal dielectric layer 120, the conformal absorber layer 130, and the second conformal dielectric layer 140 may have different surface areas.

The isotherms were collected using nitrogen physisorption at 76 K to obtain the specific surface area (SSA) of the materials, by fitting 13 points collected from P/P₀≈0.06-0.3 to the Brunauer-Emmett-Teller (BET) equation. Additional adsorption points were collected at various P/P₀, up to P/P₀≈0.95, followed by desorption back to P/P₀≈0.06. The total pore volume was determined by the volume of nitrogen adsorbed at P/P₀ 0.95, and average pore diameter was calculated using the Barrett Joyner Halenda (BJH) method.

In embodiments, the multilayer structure may have a D₅₀ diameter measured by the BET equation the amount of adsorbed gas, which build up one monolayer on the surface, can be calculated from the measured isotherm. The amount of molecules in this monolayer multiplied by the required space of one molecule gives the BET D₅₀ that is from 1 μm to 500 μm, such as from 10 μm to 500 μm, from 20 μm to 500 μm, from 25 μm to 500 μm, from 50 μm to 500 μm, from 100 μm to 500 μm, from 150 μm to 500 μm, from 200 μm to 500 μm, from 250 μm to 500 μm, from 300 μm to 500 μm, from 350 μm to 500 μm, from 400 μm to 500 μm, from 450 μm to 500 μm, from 5 μm to 450 μm, from 10 μm to 450 μm, from 20 μm to 450 μm, from 25 μm to 450 μm, from 50 μm to 450 μm, from 100 μm to 450 μm, from 150 μm to 450 μm, from 200 μm to 450 μm, from 250 μm to 450 μm, from 300 μm to 450 μm, from 350 μm to 450 μm, from 400 μm to 450 μm, from 5 μm to 400 μm, from 10 μm to 400 μm, from 20 μm to 400 μm, from 25 μm to 400 μm, from 50 μm to 400 μm, from 100 μm to 400 μm, from 150 μm to 400 μm, from 200 μm to 400 μm, from 250 μm to 400 μm, from 300 μm to 400 μm, from 350 μm to 400 μm, from 5 μm to 350 μm, from 10 μm to 350 μm, from 20 μm to 350 μm, from 25 μm to 350 μm, from 50 μm to 350 μm, from 100 μm to 350 μm, from 150 μm to 350 μm, from 200 μm to 350 μm, from 250 μm to 350 μm, from 300 μm to 350 μm, from 5 μm to 300 μm, from 10 μm to 300 μm, from 20 μm to 300 μm, from 25 μm to 300 μm, from 50 μm to 300 μm, from 100 μm to 300 μm, from 150 μm to 300 μm, from 200 μm to 300 μm, from 250 μm to 300 μm, from 5 μm to 250 μm, from 10 μm to 250 μm, from 20 μm to 250 μm, from 25 μm to 250 μm, from 50 μm to 250 μm, from 100 μm to 250 μm, from 150 μm to 250 μm, from 200 μm to 250 μm, from 5 μm to 200 μm, from 10 μm to 200 μm, from 20 μm to 200 μm, from 25 μm to 200 μm, from 50 μm to 200 μm, from 100 μm to 200 μm, from 150 μm to 200 μm, from 5 μm to 150 μm, from 10 μm to 150 μm, from 20 μm to 150 μm, from 25 μm to 150 μm, from 50 μm to 150 μm, from 100 μm to 150 μm, from 5 μm to 100 μm, from 10 μm to 100 μm, from 20 μm to 100 μm, from 25 μm to 100 μm, from 50 μm to 100 μm, from 5 μm to 50 μm, from 10 μm to 50 μm, from 20 μm to 50 μm, from 25 μm to 50 μm, from 5 μm to 25 μm, from 10 μm to 25 μm, from 20 μm to 25 μm, from 5 μm to 20 μm, from 10 μm to 20 μm, or from 5 μm to 10 μm.

The aspect ratio of the multilayer structures according to embodiments disclosed and described herein is from 1 to 100 as measure by electron microscope (TEM, SEM), with both cross-section and surface being measured, based on a large population of flakes, such as from 5 to 100, from 10 to 100, from 20 to 100, from 30 to 100, from 40 to 100, from 50 to 100, from 60 to 100, from 70 to 100, from 80 to 100, from 90 to 100, from 5 to 90, from 10 to 90, from 20 to 90, from 30 to 90, from 40 to 90, from 50 to 90, from 60 to 90, from 70 to 90, from 80 to 90, from 5 to 80, from 10 to 80, from 20 to 80, from 30 to 80, from 40 to 80, from 50 to 80, from 60 to 80, from 70 to 80, from 5 to 70, from 10 to 70, from 20 to 70, from 30 to 70, from 40 to 70, from 50 to 70, from 60 to 70, from 5 to 60, from 10 to 60, from 20 to 60, from 30 to 60, from 40 to 60, from 50 to 60, from 5 to 50, from 10 to 50, from 20 to 50, from 30 to 50, from 40 to 50, from 5 to 40, from 10 to 40, from 20 to 40, from 30 to 40, from 10 to 40, from 20 to 40, from 30 to 40, from 5 to 30, from 10 to 30, from 20 to 30, from 5 to 20, from 10 to 20, or from 5 to 10.

Embodiments of the multilayer structure 100 described above have a hue shift of less than 30°, such as less than 25°, less than 20°, less than 15°, or less than 10° in the Lab color space when viewed at angles from 0° to 45°.

In one or more embodiments, the multilayer structure 100 comprises a reflective core layer 110 made from Al, a conformal protective layer 111 made from SiO₂ encapsulating the reflective core layer 110, a conformal dielectric layer 120 made from TiO₂ encapsulating the conformal protective layer 111, a conformal barrier layer 121 made from Al₂O₃ encapsulating the conformal dielectric layer 120, and a conformal metallic absorber layer 130 made from W encapsulating the conformal barrier layer 121.

In one or more embodiments, the multilayer structure 100 comprises a reflective core layer 110 made from Al, a first conformal protective layer 111 made from SiO₂ encapsulating the reflective core layer 110, a first conformal dielectric layer 120 made from TiO₂ encapsulating the conformal protective layer 111, a conformal barrier layer 121 made from Al₂O₃ encapsulating the conformal dielectric layer 120, a conformal metallic absorber layer 130 made from W encapsulating the conformal barrier layer 121, a second conformal barrier layer 131 made from SiO₂ or Al₂O₃ encapsulating the conformal metallic absorber layer 130, and a second conformal dielectric layer 140 made from TiO₂ encapsulating the second conformal barrier layer 131.

In one or more embodiments, the multilayer structure 100 comprises a reflective core layer 110 made from Al, a first conformal protective layer 111 made from SiO₂ encapsulating the reflective core layer 110, a first conformal dielectric layer 120 made from TiO₂ encapsulating the conformal protective layer 111, a conformal barrier layer 121 made from Al₂O₃ encapsulating the conformal dielectric layer 120, a conformal metallic absorber layer 130 made from W encapsulating the conformal barrier layer 121, a second conformal barrier layer 131 made from SiO₂ or Al₂O₃ encapsulating the conformal metallic absorber layer, a second conformal dielectric layer 140 made from TiO₂ encapsulating the second conformal barrier layer 131, and a conformal outer layer 141 made from SiO₂ encapsulating the second conformal dielectric layer.

In one or more embodiments, the multilayer structure 100 comprises a reflective core layer 110 made from Al, a conformal protective layer 111 made from SiO₂ encapsulating the reflective core layer 110, a conformal dielectric layer 120 made from Fe₂O₃ encapsulating the conformal protective layer 111, a conformal barrier layer 121 made from Al₂O₃ encapsulating the conformal dielectric layer 120, and a conformal metallic absorber layer 130 made from W encapsulating the conformal barrier layer 121.

In one or more embodiments, the multilayer structure 100 comprises a reflective core layer 110 made from Al, a first conformal protective layer 111 made from SiO₂ encapsulating the reflective core layer 110, a first conformal dielectric layer 120 made from Fe₂O₃ encapsulating the conformal protective layer 111, a conformal barrier layer 121 made from Al₂O₃ encapsulating the conformal dielectric layer 120, a conformal metallic absorber layer 130 made from W encapsulating the conformal barrier layer 121, a second conformal barrier layer 131 made from SiO₂ or Al₂O₃ encapsulating the conformal metallic absorber layer, and a second conformal dielectric layer 140 made from Fe₂O₃ or TiO₂ encapsulating the second conformal barrier layer 131.

In one or more embodiments, the multilayer structure 100 comprises a reflective core layer 110 made from Al, a first conformal protective layer 111 made from SiO₂ encapsulating the reflective core layer 110, a first conformal dielectric layer 120 made from Fe₂O₃ encapsulating the conformal protective layer 111, a conformal barrier layer 121 made from Al₂O₃ encapsulating the conformal dielectric layer 120, a conformal metallic absorber layer 130 made from W encapsulating the conformal barrier layer 121, a second conformal barrier layer 131 made from SiO₂ or Al₂O₃ encapsulating the conformal metallic absorber layer, a second conformal dielectric layer 140 made from Fe₂O₃ or TiO₂ encapsulating the second conformal barrier layer 131, and a conformal outer layer 141 made from SiO₂ encapsulating the second conformal dielectric layer.

The multilayer structures in embodiments disclosed herein can be used as pigments (e.g., paint pigments for a paint used to paint an object), or a continuous thin film applied to an object. When used as pigments, at least one of paint binders and fillers can be used and mixed with the pigments to provide a paint that displays a high chroma structural color. In addition, other additives may be added to the multilayer structure to aid the compatibility of multilayer structure in the paint system. Exemplary compatibility-enhancing additives include silane surface treatments that coat the exterior of the multilayer structure and improve the compatibility of multilayer structure in the paint system. Such paint systems or films can be used on any article, including an automotive vehicle.

A first aspect includes multilayer structure that reflects color comprising: a core layer; a conformal dielectric layer encapsulating the core layer; a conformal barrier layer encapsulating the conformal dielectric layer; and a conformal absorber layer encapsulating the conformal barrier layer.

A second aspect includes the multilayer structure of the first aspect, further comprising a conformal protective layer encapsulating the core layer.

A third aspect includes, the multilayer structure of first or second aspect, further comprising: a second conformal barrier layer encapsulating the conformal absorber layer; and a second conformal dielectric layer encapsulating the second conformal barrier layer.

A fourth aspect includes, the multilayer structure of any of the first to third aspects, wherein the multilayer structure reflects a single narrow band of visible light when exposed to broadband electromagnetic radiation, the single narrow band of visible light comprising: a color shift of the single narrow band of visible light is less than 30° measured in Lab color space when the multilayer structure is exposed to broadband electromagnetic radiation and viewed from angles between 0° and 45° relative to a direction normal to an outer surface of the multilayer structure.

A fifth aspect includes, the multilayer structure of any of the first to fourth aspects, wherein the core layer has a thickness between 20 nm and 100 μm.

A sixth aspect includes, the multilayer structure of any of the first to fifth aspects, wherein the conformal dielectric layer is formed from TiO₂, ZnS, ZrO₂, HfO₂, Fe₃O₄, AlAs, Fe₂O₃, PbS, GaAs, InAs, SiO₂, MgF₂, KBr, ZnO, or Al₂O₃, and the conformal dielectric layer has a thickness between 5 nm and 500 nm.

A seventh aspect includes, the multilayer structure of any of the first to sixth aspects, wherein the conformal absorber layer is formed from W, Cr, Ge, Ni, stainless steel, Pd, Ti, Si, V, TiN, Co, Mo, Nb, ferric oxide, or combinations thereof and the conformal metallic absorber layer has a thickness between 2 nm and 50 nm.

An eighth aspect includes, the multilayer structure of any of the first to seventh aspects, wherein the conformal barrier layer is formed from Al₂O₃, SiO₂, MgF₂, KBr, or ZnO, and the conformal barrier layer has a thickness that is that is less than or equal to 50 nm.

A ninth aspect includes, the multilayer structure of any of the third to eighth aspects, wherein the second conformal dielectric layer is formed from TiO₂, ZnS, ZrO₂, HfO₂, Fe₃O₄, AlAs, Fe₂O₃, PbS, GaAs, InAs, SiO₂, MgF₂, KBr, ZnO, or Al₂O₃ and has a thickness between 5 nm and 500 nm, the conformal protective layer is formed from SiO₂, MgF₂, KBr, ZnO, or Al₂O₃, and has a thickness that is less than or equal to 50 nm, and the second conformal barrier layer is formed from SiO₂, MgF₂, KBr, ZnO, or Al₂O₃, and has a thickness that is less than or equal to 50 nm.

A tenth aspect includes, the multilayer structure of any of the first to ninth aspects, wherein the core layer is formed from Al, the conformal dielectric layer is formed from TiO₂ or Fe₂O₃, the conformal barrier layer is formed from Al₂O₃, and the conformal absorber layer is formed from W.

A eleventh aspect includes, the multilayer structure of any of the first to ninth aspects, wherein the core layer is formed from Al, the conformal protective layer is formed from SiO₂, the conformal dielectric layer is formed from TiO₂ or Fe₂O₃, the conformal barrier layer is formed from Al₂O₃, the conformal metallic absorber layer is formed from W, the second conformal barrier layer is formed from SiO₂ or Al₂O₃, and the second conformal dielectric layer is formed from TiO₂ or Fe₂O₃.

A twelfth aspect includes, the multilayer structure of any of the first to eleventh aspects, wherein each of the core layer, the conformal dielectric layer, and the conformal absorber layer individually has a pore volume that is less than or equal to 0.030 cm³/g.

A thirteenth aspect includes, the multilayer structure of any of the first to twelfth aspects, wherein each of the core layer, the conformal dielectric layer, and the conformal absorber layer individually has a pore volume that is less than or equal to 0.005 cm³/g.

A fourteenth aspect includes, the multilayer structure of any of the first to thirteenth aspects, wherein each of the core layer, the conformal dielectric layer, and the conformal absorber layer individually has a surface area less than or equal to 100 m²/g.

A fifteenth aspect includes, the multilayer structure of any of the first to fourteenth aspects, wherein each of the core layer, the conformal dielectric layer, and the conformal absorber layer individually has a surface area less than or equal to 3 m²/g.

A sixteenth aspect includes, the multilayer structure of any of the first to fifteenth aspects, wherein the multilayer structure has a D₅₀ diameter that is from 1 μm to 500 μm.

A seventeenth aspect includes, the multilayer structure of any of the first to sixteenth aspects, wherein the multilayer structure has an aspect ratio from 1 to 100.

An eighteenth aspect includes, a method for forming the multilayer structure of any of the first to seventeenth aspects, the method comprising: depositing the conformal dielectric layer onto the core layer by CVD or ALD; depositing the conformal barrier layer onto the conformal dielectric layer by ALD; and depositing the conformal absorber layer onto the conformal dielectric layer by ALD.

A nineteenth aspect includes a paint system comprising: a binder; and a multilayer structure of any of the first to seventeenth aspects.

A twentieth aspect includes an automotive vehicle comprising the paint system of the nineteenth aspect.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

### EXAMPLES

Embodiments will be further clarified by the following examples.

As noted above, high volume ALD production can result in overlap of adjacent dielectric and absorber layers that can result in degraded optical properties of the multilayer structure. It is believed that this overlap occurs because of the high porosity of the dielectric layer (such as a TiO₂ layer), which allows overlap with the absorber layer (such as W layer) applied by ALD as the metal can be impregnated into the pores of the dielectric layer. With barrier or protective layer, all the layers are well separated, so their optical properties are well predicted by simulation.

### Example 1

A multilayer structure was formed using ALD process. The multilayer structure included an aluminum reflective core layer, a conformal SiO₂ first protective layer encapsulating the reflective core layer, a conformal TiO₂ dielectric layer encapsulating the conformal SiO₂ first protective layer, a conformal Al₂O₃ barrier layer encapsulating the conformal TiO₂ dielectric layer, and a conformal W metallic absorber layer encapsulating the conformal Al₂O₃ barrier layer.

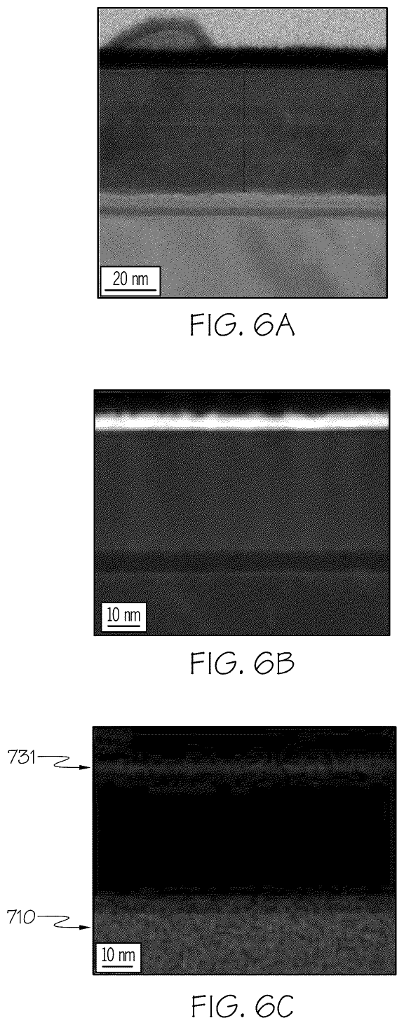

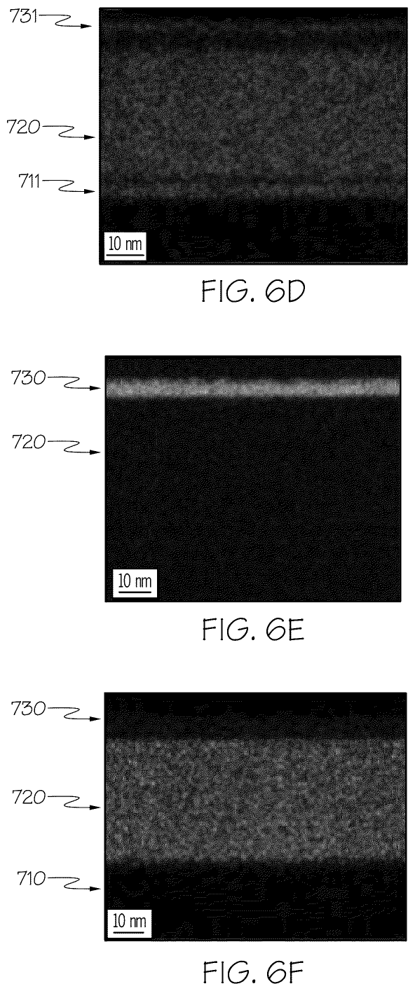

FIG. 6A is a TEM image of the as-formed multilayer structure. As shown in FIG. 6A, each layer is distinct, separate, and has a smooth surface. FIG. 6B is a further-magnified TEM image of the as-formed multilayer structure and further shows the distinct, separate, and smooth layers. FIG. 6C is a TEM image with the elemental aluminum highlighted. FIG. 6C shows that the Al reflective core layer 710 is very distinct and has a smooth surface, and it also shows a distinct Al₂O₃ barrier layer 731, both of which have smooth surfaces. FIG. 6D is a TEM image with elemental oxygen highlighted. FIG. 6D shows a distinct SiO₂ protective layer 711, a distinct TiO₂ dielectric layer 720, and a distinct Al₂O₃ barrier layer 731 that all have smooth surfaces and there is not significant overlap between the various oxygen-containing layers. FIG. 6E is a TEM image with elemental tungsten highlighted. As shown in FIG. 6E, the W absorber layer 730 is distinct and has smooth surfaces. FIG. 6E also shows there is no infiltration of tungsten into the Ti O₂ dielectric layer 720. FIG. 6F is a TEM image with elemental titanium highlighted. FIG. 6F shows a distinct TiO₂ dielectric layer 720 with smooth surfaces and no infiltration of TiO₂ into either the Al reflective core layer 710 or the W absorber layer 730.

### Comparative Example 1

A multilayer structure was formed using ALD process. The multilayer structure included an aluminum reflective core layer, a conformal SiO₂ first protective layer encapsulating the reflective core layer, a conformal TiO₂ dielectric layer encapsulating the conformal SiO₂ first protective layer, and a conformal W metallic absorber layer encapsulating the conformal TiO₂ dielectric layer. There is no barrier layer present between the TiO₂ dielectric layer and the W absorber layer.

FIG. 7A is a TEM image of the as-formed multilayer structure. As shown in FIG. 7A, tungsten from the W absorber layer infiltrated into the TiO₂ dielectric layer. FIG. 7B is a further-magnified TEM image of the as-formed multilayer structure and further shows the infiltration of W into the TiO₂ dielectric layer. FIG. 7C is a TEM image with the elemental aluminum highlighted. FIG. 7C shows that the Al reflective core layer 710 is very distinct and has a smooth surface, partially provided by the SiO₂ protective layer. FIG. 7D is a TEM image with elemental oxygen highlighted. FIG. 7D shows a denser oxygen concentration at the bottom of the TiO₂ dielectric layer (i.e., nearer the Al reflective core layer) where less tungsten was able to infiltrate. FIG. 7E is a TEM image with elemental tungsten highlighted. As shown in FIG. 7E, there is no protective layer and W infiltrated into the TiO₂. FIG. 7F is a TEM image with elemental titanium highlighted. FIG. 7F shows a higher concentration of Ti at the bottom of the TiO₂ dielectric layer (i.e., nearer the Al reflective core layer) where less tungsten was able to infiltrate.

As Example 1 and Comparative Example 1 above show, by depositing an Al₂O₃ barrier layer between the TiO₂ dielectric layer and the W absorber layer, the multilayer structure has well-separated dielectric and absorber layers that give rise to multilayer structure with improved chromaticity compared to a multilayer structure where no barrier layer is present between the TiO₂ dielectric layer and the W absorber layer.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A multilayer structure that reflects color comprising:
a core layer;
a conformal dielectric layer encapsulating the core layer;
a conformal barrier layer encapsulating the conformal dielectric layer; and
a conformal absorber layer encapsulating the conformal barrier layer.

2. The multilayer structure of claim 1, further comprising a conformal protective layer encapsulating the core layer.

3. The multilayer structure of claim 2, further comprising:
a second conformal barrier layer encapsulating the conformal absorber layer; and
a second conformal dielectric layer encapsulating the second conformal barrier layer.

4. The multilayer structure of claim 1, wherein the multilayer structure reflects a single narrow band of visible light when exposed to broadband electromagnetic radiation, the single narrow band of visible light comprising:
a color shift of the single narrow band of visible light is less than 30° measured in Lab color space when the multilayer structure is exposed to broadband electromagnetic radiation and viewed from angles between 0° and 45° relative to a direction normal to an outer surface of the multilayer structure.

5. The multilayer structure of claim 1, wherein the core layer has a thickness between 20 nm and 100 μm.

6. The multilayer structure of claim 1, wherein
the conformal dielectric layer is formed from TiO₂, ZnS, ZrO₂, HfO₂, Fe₃O₄, AlAs, Fe₂O₃, PbS, GaAs, InAs, SiO₂, MgF₂, KBr, ZnO, or Al₂O₃, and
the conformal dielectric layer has a thickness between 5 nm and 500 nm.

7. The multilayer structure of claim 1, wherein
the conformal absorber layer is formed from W, Cr, Ge, Ni, stainless steel, Pd, Ti, Si, V, TiN, Co, Mo, Nb, ferric oxide, or combinations thereof, and
the conformal absorber layer has a thickness between 2 nm and 50 nm.

8. The multilayer structure of claim 1, wherein
the conformal barrier layer is formed from Al₂O₃, SiO₂, MgF₂, KBr, or ZnO, and
the conformal barrier layer has a thickness that is that is less than or equal to 50 nm.

9. The multilayer structure of claim 3, wherein
the second conformal dielectric layer is formed from TiO₂, ZnS, ZrO₂, HfO₂, Fe₃O₄, AlAs, Fe₂O₃, PbS, GaAs, InAs, SiO₂, MgF₂, KBr, ZnO, or Al₂O₃ and has a thickness between 5 nm and 500 nm,
the conformal protective layer is formed from SiO₂, MgF₂, KBr, ZnO, or Al₂O₃, and has a thickness that is less than or equal to 50 nm, and
the second conformal barrier layer is formed from SiO₂, MgF₂, KBr, ZnO, or Al₂O₃, and has a thickness that is less than or equal to 50 nm.

10. The multilayer structure of claim 1, wherein
the core layer is formed from Al,
the conformal dielectric layer is formed from TiO₂ or Fe₂O₃,
the conformal barrier layer is formed from Al₂O₃, and
the conformal absorber layer is formed from W.

11. The multilayer structure of claim 3, wherein
the core layer is formed from Al,
the conformal protective layer is formed from SiO₂ or Al₂O₃,
the conformal dielectric layer is formed from TiO₂ or Fe₂O₃,
the conformal barrier layer is formed from Al₂O₃,
the conformal absorber layer is formed from W,
the second conformal barrier layer is formed from SiO₂ or Al₂O₃, and
the second conformal dielectric layer is formed from TiO₂ or Fe₂O₃.

12. The multilayer structure of claim 1, wherein each of the core layer, the conformal dielectric layer, and the conformal absorber layer individually has a pore volume that is less than or equal to 0.030 cm³/g.

13. The multilayer structure of claim 1, wherein each of the core layer, the conformal dielectric layer, and the conformal absorber layer individually has a pore volume that is less than or equal to 0.005 cm³/g.

14. The multilayer structure of claim 1, wherein each of the core layer, the conformal dielectric layer, and the conformal absorber layer individually has a surface area less than or equal to 100 m²/g.

15. The multilayer structure of claim 1, wherein each of the core layer, the conformal dielectric layer, and the conformal absorber layer individually has a surface area less than or equal to 5 m²/g.

16. The multilayer structure of claim 1, wherein the multilayer structure has a D₅₀ diameter that is from 1 μm to 500 μm.

17. The multilayer structure of claim 1, wherein the multilayer structure has an aspect ratio from 1 to 100.

18. A method for forming the multilayer structure of claim 1, the method comprising:
depositing the conformal dielectric layer onto the core layer by CVD or ALD;
depositing the conformal barrier layer onto the conformal dielectric layer by ALD; and
depositing the conformal absorber layer onto the conformal dielectric layer by ALD.

19. A paint system comprising:
a binder; and
a multilayer structure of claim 1.

20. An automotive vehicle comprising the paint system of claim 19.
